(19) United States
(12) Patent Application Publication
(10) Pub. No.: US 2009/0007207 A1
(43) Pub. Date: Jan. 1, 2009

(54) HARDWARE-IMPLEMENTED HANDLING OF BACK-TO-BACK AND PARALLEL TIME SLICES IN A VIDEO BROADCASTING RECEIVER

(75) Inventors: Neeraj Kashalkar, Irvine, CA (US); Hongfan Wang, Lake Forest, CA (US); Stephen Mueller, Foothill Ranch, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 12/040,650

(22) Filed: Feb. 29, 2008

Related U.S. Application Data
(60) Provisional application No. 60/947,007, filed on Jun. 29, 2007.

(51) Int. Cl. H04J 3/00; H04N 5/44

(52) U.S. Cl. 725/113; 370/498

(57) ABSTRACT

A hardware-implemented video broadcasting receiver is described that is capable handling back-to-back and parallel time slices in an efficient manner, thereby providing improved receiver performance. In one implementation, the hardware-implemented video broadcasting receiver is capable of handling back-to-back time slices of up to 2 Megabits (Mbits) each and, depending upon the MPE-FEC frame size associated with each time slice, up to 8 parallel time slices or up to 4 parallel time slices transmitted back-to-back with 4 other parallel time slices. The hardware-implemented video broadcasting receiver advantageously permits more efficient and flexible use of the available spectrum and increases interoperability with other DVB-H compliant equipment.

### CROSS-REFERENCE TO RELATED APPLICATIONS

This application claims priority to Provisional U.S. Patent Application No. 60/947,007, entitled “Hardware-Implemented Handling of Parallel and Consecutive Time Slices in a DVB-H System on Chip,” filed Jun. 29, 2007, the entirety of which is incorporated by reference herein.

### BACKGROUND OF THE INVENTION

1. Field of the Invention

The present invention generally relates to video broadcasting receivers, including but not limited to DVB-H (Digital Video Broadcasting-Handheld) receivers.

2. Background

DVB-H is a technical specification for bringing broadcast services to handheld devices. DVB-H may be considered a superset of the DVB-T (Digital Video Broadcasting-Terrestrial) specification for digital terrestrial television, with additional features to meet the specific requirements of handheld, battery-powered terminals. DVB-H was formally adopted in November of 2004 as ETSI standard EN 302 304 (referred to herein as “the DVB-H standard”), the entirety of which is incorporated by reference as if fully set forth herein.

The DVB-H standard employs a technique called “time slicing” to reduce the average power consumption by the handheld terminal. Time slicing consists of sending data in bursts using a significantly higher instantaneous bit rate compared to the bit rate required if the data were transmitted using traditional streaming mechanisms. To indicate to the DVB-H receiver when to expect the next burst, the time to the beginning of the next burst (“delta-t”) is indicated within the burst currently being received. Between the bursts, data associated with the elementary stream(s) included in the bursts is not transmitted, allowing other elementary streams to share the capacity otherwise allocated. Time slicing enables a receiver to stay active for only a fraction of the time, i.e. when receiving bursts of a requested service.

The DVB-H standard allows for two time slices to be transmitted “back-to-back” within a given burst. One example of this is illustrated in timeline 100 of FIG. 1, which shows two sequential bursts 102 and 104, each of which includes two time slices TS1 and TS2 that are transmitted back-to-back.

The DVB-H standard also allows multiple time slices to be transmitted in parallel within a given burst. This is referred to herein as “parallel time slices.” An example of this is illustrated in timeline 200 of FIG. 2, which shows two sequential bursts 202 and 204, each of which includes four different time slices (TS1, TS2, TS3 and TS4) being transmitted over the same period of time. In practice, this is achieved by multiplexing transport stream packets from the four different time slices together into a single transport stream and then broadcasting the transport stream.

A burst may also include parallel time slices transmitted back-to-back with other parallel time slices. An example of this is illustrated in timeline 300 of FIG. 3, which shows two sequential bursts 302 and 304, each of which includes eight time slices TS1-TS8. The time slices TS1, TS2, TS3 and TS4 are transmitted in parallel and are immediately followed by the time slices TS5, TS6, TS7 and TS8, which are also transmitted in parallel.

To permit more efficient and flexible use of the available spectrum and to ensure interoperability with other DVB-H compliant equipment, it would be desirable for a DVB-H receiver to be able to flexibly accommodate transmission schemes that include back-to-back time slices, parallel time slices, or a combination of both within a given burst. The desired DVB-H receiver should further provide functionality for handling each burst type in hardware so as to improve the performance of the DVB-H receiver. Furthermore, the desired DVB-H receiver should implement such functionality in a manner that takes into account the resource limitations of a handheld receiver.

### BRIEF SUMMARY OF THE INVENTION

A hardware-implemented video broadcasting receiver is described that is capable of handling back-to-back and parallel time slices in an efficient manner, thereby providing improved receiver performance. In one implementation, the hardware-implemented video broadcasting receiver is capable of handling back-to-back time slices of up to 2 Megabits (Mbits) each and, depending upon the MPE-FEC frame size associated with each time slice, up to 8 parallel time slices or up to 4 parallel time slices transmitted back-to-back with 4 other parallel time slices. The hardware-implemented video broadcasting receiver advantageously permits more efficient and flexible use of the available spectrum and increases interoperability with other DVB-H compliant equipment.

In one embodiment described herein, the hardware-implemented video broadcasting receiver includes a transport stream packet filter, a section manager connected to the transport stream packet filter, a frame manager connected to the section manager, and an Internet Protocol (IP) filter connected to the frame manager. The transport stream packet filter is configured to receive transport stream packets associated with a plurality of time slices. The section manager is configured to track the building of sections associated with each of the plurality of time slices in parallel, wherein the sections are built using data from the transport stream packets. The frame manager is configured to build MPE-FEC frames associated with each of the plurality of time slices in parallel, wherein the MPE-FEC frames are built using data from the sections and wherein building the MPE-FEC frames in parallel includes dynamically allocating one or more frame buffers within a plurality of frame buffers to each of the MPE-FEC frames. The IP filter is configured to generate IP packets from each of the MPE-FEC frames.

The section manager may be further configured to track the building of the MPE-FEC frames associated with each of the plurality of time slices in parallel.

The foregoing hardware-implemented video broadcasting receiver may further include a demodulator connected to the transport stream packet filter, wherein the demodulator is configured to receive in-phase (I) and quadrature (Q) signal components and to convert the received I and Q signal components to generate the transport stream packets.

In one implementation of the foregoing hardware-implemented video broadcasting receiver, the section manager is configured to track the building of two to eight sections in parallel and the frame manager is configured to build from two to eight MPE-FEC frames in parallel. In further accordance with such an implementation, the plurality of frame buffers may consist of eight frame buffers and each frame buffer may be configured to hold 256 rows of an MPE-FEC frame.

The section manager may also be configured to track the building of sections associated with a given time slice responsive to an indication that the frame manager can allocate a sufficient number of frame buffers to accommodate an MPE-FEC frame associated with the given time slice.

In a further implementation of the foregoing hardware-implemented video broadcasting receiver, the frame manager is configured to dynamically allocate a number of frame buffers to an MPE-FEC frame based on a frame size associated with the MPE-FEC frame. The frame manager may also be configured to recycle one or more frame buffers allocated to an MPE-FEC frame responsive to determining that the MPE-FEC frame has been drained by the IP filter.

In a still further implementation of the foregoing hardware-implemented video broadcasting receiver, the section manager is further configured to generate erasure information associated with each MPE-FEC frame and the frame manager is configured to receive the erasure information and store it in an erasure table associated with the MPE-FEC frame.

A method for parallel processing of multiple time slices in a hardware-implemented video broadcasting receiver is also described herein. In accordance with the method, transport stream packets associated with a plurality of time slices are received. The building of sections associated with each of the plurality of time slices are tracked in parallel, wherein the sections are built using data from the transport stream packets. MPE-FEC frames associated with each of the plurality of time slices are built in parallel, wherein the MPE-FEC frames are built using data from the sections and wherein building the MPE-FEC frames in parallel includes dynamically allocating one or more frame buffers within a plurality of frame buffers to each of the MPE-FEC frames. IP packets are then generated from each one of the MPE-FEC frames.

In accordance with the foregoing method, tracking the building of sections in parallel may include tracking the building of two to eight sections in parallel and building MPE-FEC frames in parallel may include building an equal number of MPE-FEC frames in parallel. Furthermore, dynamically allocating one or more frame buffers within a plurality of frame buffers to each of the MPE-FEC frames may include dynamically allocating one or more frame buffers within a set of eight frame buffers. Each of the eight frame buffers may be configured to hold 256 rows of an MPE-FEC frame.

In accordance with the foregoing method, tracking the building of sections may also include tracking the building of sections associated with a given time slice responsive to an indication that a sufficient number of frame buffers can be allocated to accommodate an MPE-FEC frame associated with the given time slice.

The foregoing method may also include receiving in-phase (I) and quadrature (Q) signal components and converting the received I and Q signal components to generate the transport stream packets. The foregoing method may further include recycling one or more frame buffers allocated to an MPE-FEC frame responsive to determining that the MPE-FEC frame has been drained by the IP filter. The foregoing method may still further include generating erasure information associated with each MPE-FEC frame and storing the erasure information in an erasure table associated with the MPE-FEC frame.

A hardware-implemented video broadcasting receiver is also described herein. The receiver includes means for receiving transport stream packets associated with a plurality of time slices. The receiver also includes means for tracking the building of sections associated with each of the plurality of time slices in parallel, wherein the sections are built using data from the transport stream packets. The receiver further includes means for building MPE-FEC frames associated with each of the plurality of time slices in parallel, wherein the MPE-FEC frames are built using data from the sections and wherein building the MPE-FEC frames in parallel includes dynamically allocating one or more frame buffers within a plurality of frame buffers to each of the MPE-FEC frames. The receiver still further includes means for generating IP packets from each of the MPE-FEC frames.

The foregoing hardware-implemented video broadcasting receiver may further include means for tracking the building of the MPE-FEC frames associated with each of the plurality of time slices in parallel. The foregoing hardware-implemented video broadcasting receiver may also include means for receiving in-phase (I) and quadrature (Q) signal components and for converting the received I and Q signal components to generate the transport stream packets.

In one implementation of the foregoing hardware-implemented video broadcasting receiver, the means for tracking the building of sections comprises means for tracking the building of two to eight sections in parallel and the means for building MPE-FEC frames comprises means for building from two to eight MPE-FEC frames in parallel. In further accordance with such an implementation, the plurality of frame buffers may consist of eight frame buffers and each frame buffer may be configured to hold 256 rows of an MPE-FEC frame.

The means for tracking the building of sections may also include means for tracking the building of sections associated with a given time slice responsive to an indication that the means for building MPE-FEC frames can allocate a sufficient number of frame buffers to accommodate an MPE-FEC frame associated with the given time slice.

In a further implementation of the foregoing hardware-implemented video broadcasting receiver, the means for building frames includes means for recycling one or more frame buffers allocated to an MPE-FEC frame responsive to determining that the MPE-FEC frame has been drained by the means for generating IP packets. The means for tracking the building of sections may also include means for generating erasure information associated with each MPE-FEC frame and the means for building MPE-FEC frames may also include means for receiving the erasure information and storing it in an erasure table associated with the MPE-FEC frame.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a timeline that shows two sequential bursts, each of which includes two back-to-back time slices.

FIG. 2 is a timeline that shows two sequential bursts, each of which includes four parallel time slices.

FIG. 3 is a timeline that shows two sequential bursts, each of which includes four parallel time slices back-to-back with four other parallel time slices.

FIG. 4 is a block diagram of an example DVB-H receiver in accordance with an embodiment of the present invention.

FIG. 5 depicts a flowchart of a method by which a DVB-H receiver in accordance with an embodiment of the present invention processes multiple time slices in parallel.

FIG. 6 is a block diagram of a transport stream packet filter in accordance with an embodiment of the present invention.

FIG. 7 is a block diagram of a section manager in accordance with an embodiment of the present invention.

FIG. 8 is a block diagram of a frame manager in accordance with an embodiment of the present invention.

FIG. 9 is a logical representation of an MPE-FEC frame.

FIG. 10 is a diagram illustrating a physical implementation of a plurality of frame buffers for storing MPE-FEC frames in accordance with an embodiment of the present invention.

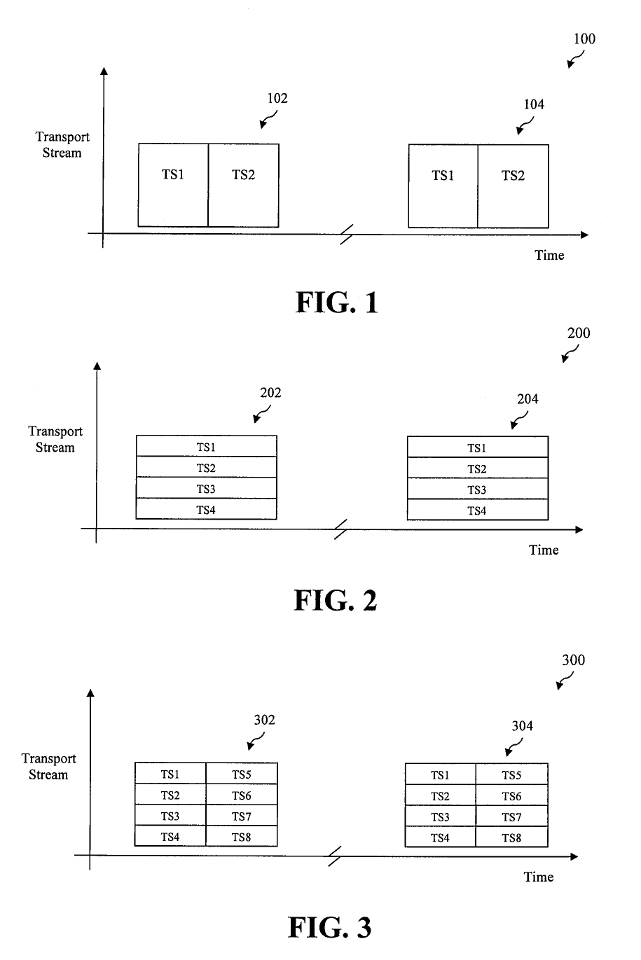

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The present specification discloses one or more embodiments of a DVB-H receiver that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### B. Overview of DVB-H Receiver in Accordance With an Embodiment of the Present Invention

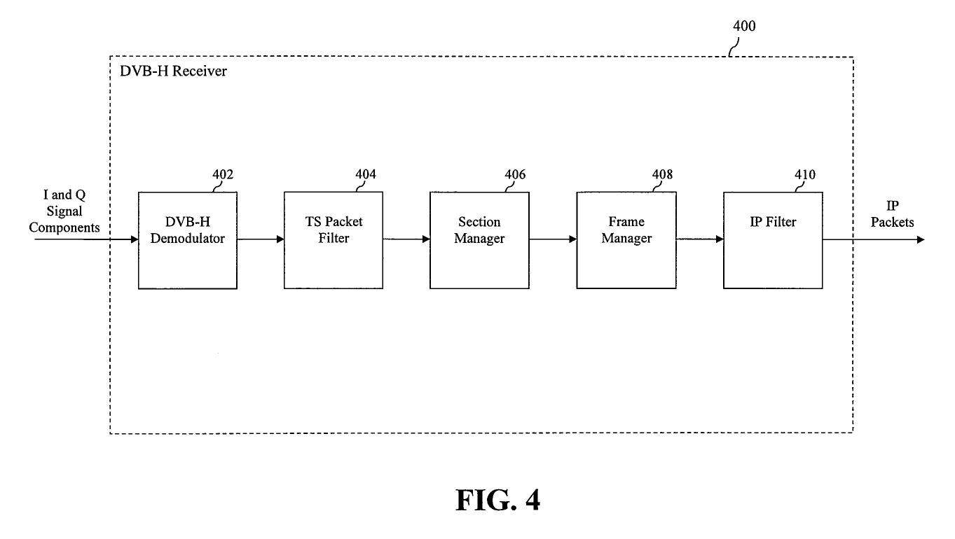

FIG. 4 is a block diagram of an example DVB-H receiver 400 in accordance with an embodiment of the present invention. As shown in FIG. 4, DVB-H receiver 400 includes a number of interconnected logic blocks including a DVB-H demodulator 402, a transport stream (TS) packet filter 404, a section manager 406, a frame manager 408 and an IP filter 410. Each of these logic blocks is implemented in hardware using analog and/or digital circuits, although certain operating parameters of the logic blocks may be configured in software. The logic blocks may together form a part of a single integrated circuit chip.

Generally speaking, these hardware-implemented logic blocks work together to allow multiple time slices received by DVB-H receiver 400 to be processed in parallel, thereby enabling DVB-H receiver 400 to handle back-to-back and parallel time slices in an efficient manner and thereby also providing improved receiver performance. In one embodiment described herein, DVB-H receiver 400 is capable of handling back-to-back time slices of up to 2 Megabits (Mbits) each and, depending upon the MPE-FEC frame size associated with each time slice, up to 8 parallel time slices or up to 4 parallel time slices transmitted back-to-back with 4 other parallel time slices. DVB-H receiver 400 thus advantageously permits more efficient and flexible use of the available spectrum and increases interoperability with other DVB-H compliant equipment.

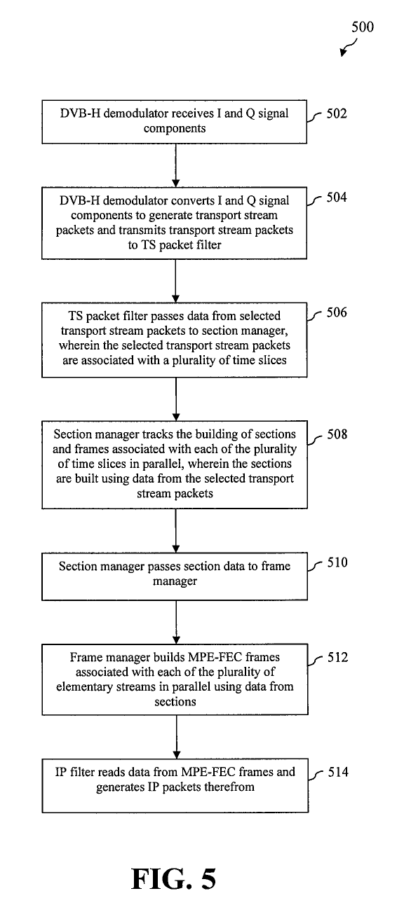

FIG. 5 depicts a flowchart 500 of a method by which DVB-H receiver 400 processes multiple time slices in parallel. The steps of flowchart 500 will now be described in reference to the various logic blocks of DVB-H receiver 400, although the method is not limited to that implementation. The manner in which the logic blocks of DVB-H receiver 400 operate to perform each of these method steps will be described in more detail in Section C, below.

As shown in FIG. 5, the method of flowchart 500 begins at step 502 in which DVB-H demodulator 402 receives in-phase (I) and quadrature (Q) signal components carrying DVB-H video or audio/video (A/V) content. At step 504, responsive to receiving the I and Q signal components, DVB-H demodulator 402 converts the received I and Q signal components to generate transport stream packets and transmits the transport stream packets to TS packet filter 404.

At step 506, TS packet filter 404 passes data from selected transport stream packets to section manager 406, wherein the selected transport stream packets are associated with a plurality of time slices. As will be appreciated by persons skilled in the relevant art(s), the association between a transport stream packet and a time slice may be indicated by a packet identifier (PID) embedded in the header of each transport stream packet.

At step 508, section manager 406 tracks the building of sections associated with each of the plurality of time slices in parallel, wherein the sections are built using data from the selected transport stream packets. As will be described in more detail herein, section manager 406 is also configured to track the building of MPE-FEC frames associated with each of the plurality of time slices in parallel. In one embodiment of the present invention, section manager 406 is configured to track the building of two to eight sections and two to eight frames in parallel. At step 510, section manager passes section data to frame manager 408.

At step 512, frame manager 408 builds MPE-FEC frames associated with each of the plurality of time slices in parallel using the data provided by section manager 406. In one embodiment of the present invention, frame manager 408 is configured to build from two to eight MPE-FEC frames in parallel.

As will be described in more detail herein, frame manager 408 builds the MPE-FEC frames in parallel, in part, by dynamically allocating one or more frame buffers within a plurality of frame buffers to each of the MPE-FEC frames. Frame manager 408 is configured to determine the number of frame buffers to allocate to a particular MPE-FEC frame based on a frame size associated with the MPE-FEC frame. In one embodiment of the present invention, the plurality of frame buffers consists of eight frame buffers, each of which is configured to hold 256 rows of an MPE-FEC frame. As will also be described in more detail herein, section manager 406 may be configured to track the building of sections associated with a given time slice only upon receiving an indication that frame manager 408 can allocate a sufficient number of frame buffers to accommodate an MPE-FEC frame associated with the given time slice.

At step 514, IP filter 410 reads data from the MPE-FEC frames built by frame manager 408 and generates IP packets therefrom. These IP packets may then be transferred to an application program executing on a system or device that is communicatively connected to DVB-H receiver 400 or that is executing on a system or device of which DVB-H receiver 400 is a part. In an embodiment, responsive to determining that IP filter 410 has drained an entire MPE-FEC frame from frame manager 408, frame manager 408 recycles one or more frame buffers allocated to the MPE-FEC frame so that they are available to store new MPE-FEC frames.

### C. Detailed Description of DVB-H Receiver in Accordance With an Embodiment of the Present Invention

The following is a detailed description of the logic blocks of DVB-H receiver 400 and the manner in which they operate to perform the functions described above in reference to flowchart 500 of FIG. 5, as well as other related and unrelated functions. The details provided in this Section illustrate only one manner in which certain aspects of the present invention may be implemented, and therefore are not intended to be limiting.

1. DVB-H Demodulator

DVB-H demodulator 402 is configured to receive I and Q signal components carrying DVB-H video or A/V content and to convert those signal components to produce an MPEG-2 transport stream for delivery to TS packet filter 404. As will be appreciated by persons skilled in the art, the MPEG-2 transport stream is comprised of a series of 188-byte transport stream packets, each of which is associated with a unique elementary stream or packet ID (PID). DVB-H demodulator 402 is also configured to perform Reed-Solomon error-correction decoding on the TS packets.

The I and Q signal components received by DVB-H demodulator 402 may be produced by the combination of an RF tuner and analog-to-digital converter (not shown in FIG. 4), each of which may be external with respect to DVB-H receiver 400 or each of which may be an integrated part of DVB-H receiver 400.

The signals output from DVB-H demodulator 402 to TS packet filter 404 in accordance with one implementation of the present invention are represented in Table 1 below.

TABLE 1
Signals Output from DVB-H Demodulator to TS Packet Filter

| Signal Name | Pins | Active |
|---|---|---|
| ts_clk | 1 | N/A |
| ts_start | 1 | High |
| ts_valid | 1 | High |
| ts_data [7:0] | 8 | N/A |
| ts_err [1:0] | 2 | N/A |

In Table 1, “signal name” identifies the name of a given signal, “pins” specifies the number of pins or wires used to carry a given signal from DVB-H demodulator 402 to TS packet filter 404, and “active” specifies (where applicable) whether a given signal is active high or active low. Similar designations will be used elsewhere herein to describe signals that are input and/or output from other logic blocks within example DVB-H receiver 400. Each of the signals in Table 1 will now be briefly described.

The signal ts_clk is a transport stream clock used by DVB-H demodulator 402 for the transmission of signals to TS packet filter 404.

The signal ts_data [7:0] is used to carry consecutive bytes in the MPEG-2 transport stream from DVB-H demodulator 402 to TS packet filter 404.

The signal ts_start is asserted to indicate the start of a transport stream packet. In particular, when ts_start goes high for one clock cycle, this indicates that the byte currently being transmitted on ts_data [7:0] is the first byte of a new transport stream packet.

The signal ts_valid is asserted to indicate that ts_data [7:0] is valid. This signal is set high for an entire 188-byte transport stream packet.

The signal ts_err [1:0] provides error information concerning the transport stream packet currently being transmitted to TS packet filter 404. Such error information is provided by a Reed-Solomon decoder within DVB-H demodulator 402. A value of “00” indicates that the transport stream packet is error-free, a value of “01” indicates that the transport stream packet has been corrected, a value of “10” indicates that the transport stream packet contains uncorrectable errors, and the value “11” is reserved. The signal ts_err [1:0] is held stable for an entire 188-byte transport stream packet.

2. TS Packet Filter

TS packet filter 404 is configured to receive transport stream packets from DVB-H demodulator 402 and to selectively pass section data embedded in certain transport stream packets on to section manager 406 along with associated control and status information.

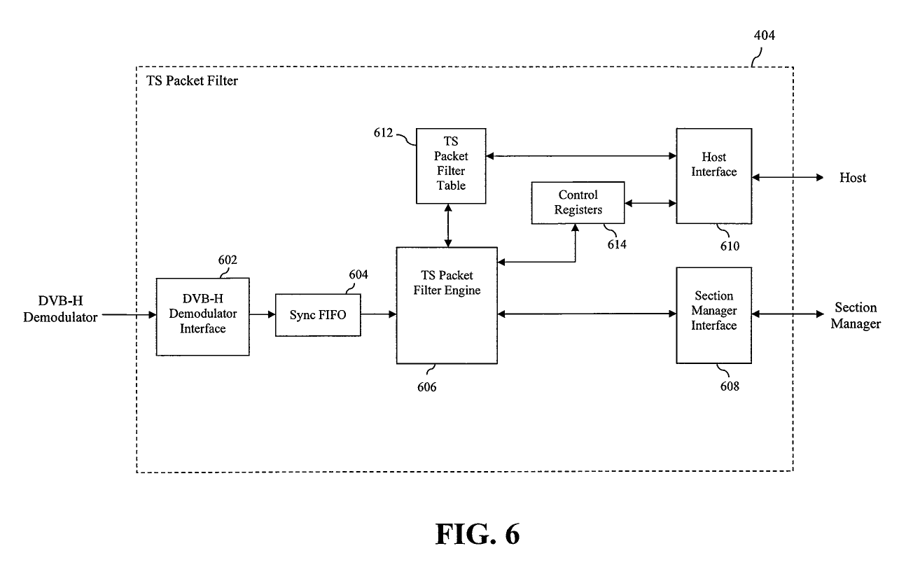

FIG. 6 is a block diagram that shows TS packet filter 404 in more detail. As shown in FIG. 6, TS packet filter 404 includes a number of interconnected logic blocks including a DVB-H demodulator interface 602, a synchronization (sync) FIFO 604, a TS packet filter engine 606, a section manager interface 608, a host interface 610, a TS packet filter table 612 and control registers 614. Each of these logic blocks will be described in more detail below.

DVB-H demodulator interface 602 is configured to receive various signals output from DVB-H demodulator 402 that were described above in reference to Table 1. In particular, DVB-H demodulator interface 602 is configured to monitor the ts_start signal from DVB-H demodulator 402 to determine when DVB-H demodulator 402 is sending a new transport stream packet. Responsive to the ts_start signal going high, DVB-H demodulator interface 602 receives an 188-byte transport stream packet from DVB-H demodulator 402 one byte at a time via ts_data [7:0] and transfers it into sync FIFO 604 when there is sufficient free space to do so. If there is insufficient free space in sync FIFO 604, then the entire transport stream packet is dropped, a counter is incremented, and an error interrupt signal is signaled to an entity external to DVB-H receiver 400.

Sync FIFO 604 provides a clock boundary between the ts_clk from DVB-H demodulator 402 and a system clock utilized by TS packet filter 404. In one implementation, sync FIFO is 1024 bytes deep and thus can hold more than 5 complete 188-byte transport stream packets.

TS packet filter engine 606 is configured to obtain transport stream packets out of sync FIFO 604. TS packet filter engine 606 is further configured to selectively pass section data embedded in certain TS packets on to section manager 406 along with associated control and status information. TS packet filter engine 606 performs this filtering function based on information obtained (1) from the header of each transport stream packet, (2) from TS packet filter table 612, and (3) from control registers 614.

An important function of TS packet filter engine 606 is to ensure that certain time slices that are of interest to a host are processed while those that are not are ignored. To facilitate this function, host interface 610 of TS packet filter 404 allows a host to identify up to 32 different valid PIDs in TS packet filter table 612. These PIDs may be referred to herein as “requested PIDs.” When TS packet filter engine 606 processes a transport stream packet, it determines if a PID in the header of the transport stream packet matches a valid PID stored in table 612. If the PID from the header does not match a valid PID stored in table 612, then the transport stream packet is discarded. If the PID from the header does match a valid PID stored in table 612, then the transport stream packet may be retained depending on other filtering functions performed by TS packet filter engine 606.

In one implementation, TS packet filter table 612 includes one row for each of the 32 PIDs. Each row may also include other parameters that can be used by TS packet filter engine 606 to filter transport stream packets associated with a particular PID. In contrast, control registers 614 may include global parameters that are used by TS packet filter engine 606 to filter transport stream packets regardless of which PID they are associated with. Both TS packet filter table 612 and control registers 614 are configurable via host interface 508.

If TS packet filter engine 606 determines that section data in a transport stream packet should be transmitted to section manager 406, then TS packet filter engine 606 sends the section data and associated control and status information to section manager 406 via section manager interface 608. The information is sent using the signals shown in Table 2 below. Each of these signals will now be described.

TABLE 2
Signals Output from TS Packet Filter to Section Manager

| Signal Name | Pins | Active |
|---|---|---|
| pf_data [31:0] | 32 | N/A |
| pf_byte_valid [3:0] | 4 | High |
| pf_new_section | 1 | High |
| pf_data_valid | 1 | High |
| pf_pid [12:0] | 13 | N/A |
| pf_erasure | 1 | High |
| pf_squ_ind | 1 | High |
| pf_lkup_ptr [4:0] | 5 | N/A |
| pf_cntl_val | 1 | High |

The signal pf_data [31:0] is used to carry 4 bytes of section data associated with the PID indicated by pf_pid. The data bytes are arranged in a big-endian fashion such that the first byte in a new section will be on pf_data [31:24].

The signal pf_byte_valid [3:0] is used to indicate whether each data byte in pf_data [31:0] is valid. The signals pf_byte_valid [0], [1], [2] and [3] correspond to pf_data [7:0], [15:8], [23:16] and [31:24], respectively.

The signal pf_new_section is asserted to indicate that the bytes being transferred over pf_data [31:0] are the first bytes in a new section associated with the PID indicated by pf_pid. In accordance with DVB-H data mapping conventions, a section may be spread across multiple transport stream packets such that multiple packet payloads together form a section. To address this, TS packet filter engine 506 is configured to use information provided in the transport stream packet headers to determine where one section ends and a subsequent section begins.

The signal pf_data_valid is asserted to indicate that the signals pf_data [31:0], pf_byte_valid and pf_new section are valid.

The signal pf_pid [12:0] is used to carry the 13-bit PID associated with the section data being transmitted to section manager 406.

The signal pf_erasure is used to specify the error conditions of the transport stream packet that included the section data being transmitted. When asserted, this signal indicates that the relevant transport stream packet was received from DVB-H demodulator 402 with errors. Depending upon the implementation, the determination of whether the relevant transport stream packet was received from DVB-H demodulator 402 with errors may be based on the ts_err [1:0] signal received from DVB-H demodulator 402, based on header information included in the relevant transport stream packet, or based on both.

The signal pf_squ_ind is asserted to indicate that the transport stream packet that included the section data being transmitted was received out of sequence. TS packet filter engine 606 is configured to determine whether a transport stream packet has been received out of sequence by comparing counters located in the packet headers of consecutively-received transport stream packets associated with the same PID.

The signal pf_lkup_ptr [4:0] is a pointer that indicates the position of the PID indicated by pf_pid within TS packet filter table 612. As will be described in more detail herein, this pointer is used by section manager 406 to access a similarly-organized table that is logically associated with TS packet filter table 612.

The signal pf_cntl_val is asserted to indicate to section manager 406 that the control signals pf_erasure, pf_squ_ind, pf_lkup_ptr and pf_pid should be sampled.

TS packet filter engine 606 will only send section data to section manager 406 when section manager 406 provides an indication that a buffer within section manager 406 used to hold such data is not full. The signal used to indicate this condition, sm_full, is set forth in Table 3 below.

TABLE 3
Signal Input to TS Packet Filter from Section Manager

| Signal Name | Pins | Active |
|---|---|---|
| sm_full | 1 | High |

When sm_full is asserted, the buffer within section manager 406 is full and no section data may be transmitted.

3. Section Manager

Among other functions, section manager 406 is configured to track the status of sections built from section data transmitted from TS packet filter 404, as well as to track the status of frames built from such sections. In particular, section manager 406 is configured to concurrently track the status of sections and frames associated with anywhere from one to eight different time slices, depending on the frame size associated with each time slice. Section manager 406 is also configured to transmit frame data, along with associated erasure information, status information and control information, to frame manager 408. This information is used by frame manager 408 to construct one to eight MPE-FEC frame(s) using one to eight frame buffers located within frame manager 408 and, when applicable, to perform error correction operations on the MPE-FEC frame(s).

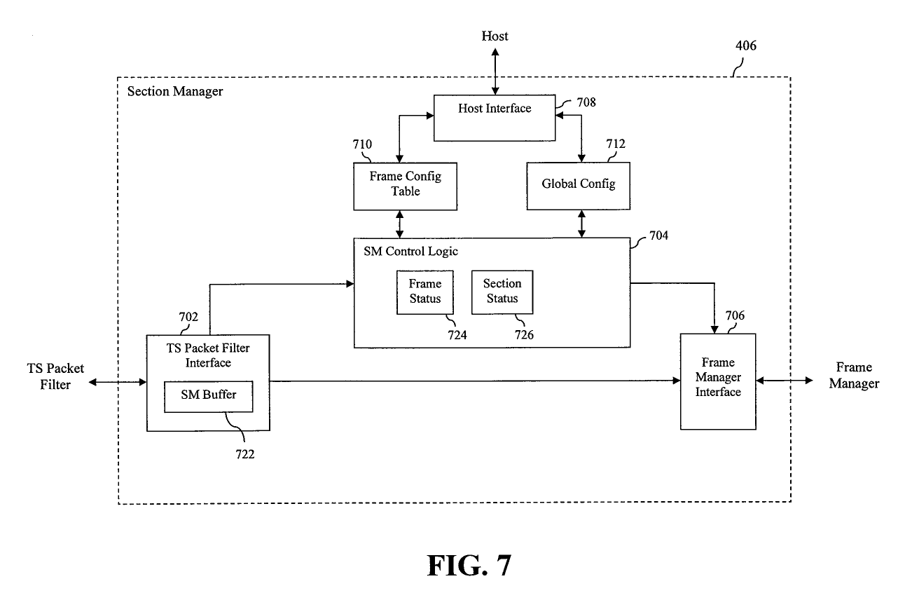

FIG. 7 is a block diagram that shows section manager 406 in more detail. As shown in FIG. 7, section manager 406 includes a number of interconnected logic blocks including a TS packet filter interface 702, SM control logic 704, a frame manager interface 706, a host interface 708, a frame configuration table 710 and a global configuration register 712. Each of these logic blocks will be described in more detail below.

TS packet filter interface 702 is configured to send and receive signals to and from TS packet filter 404. In particular, TS packet filter interface 702 is configured to receive the signals described above in reference to Table 2 from TS packet filter 404. TS packet filter interface 702 is also configured to temporarily store section data received from TS packet filter 404 in an SM buffer 722 to facilitate processing by SM control logic 704. When SM buffer 722 becomes full, TS packet filter interface 702 asserts the sm_full signal (described above in reference to Table 3), which causes TS packet filter 404 to stop transmitting section data.

SM control logic 704 is configured to perform a number of functions including tracking the building of sections and frames and controlling the transmission of frame data, erasure information, status information and control information to frame manager 408. For example, control logic 704 maintains a section status data structure 726 that is used to track the building of up to eight sections in parallel for use in building up to eight corresponding MPE-FEC frames. Status information maintained in data structure 726 for each section may include, but is not limited to, whether or not the section is valid, whether or not the section is an MPE section, whether or not the section is an FEC section, whether or not the section is a table, current partial cyclic redundancy check (CRC) results associated with the section, as well as information from and/or about the section header associated with the section.

It should be noted that sections are not actually built and stored within section manager 406. Rather, SM control logic 704 updates the status of sections currently being assembled within frame manager 408 by processing section data (and associated control/status signals) received from TS packet filter 404 “on the fly” prior to forwarding the section data to frame manager 408. In one embodiment, the section data need only reside in SM buffer 722 for one clock cycle prior to being forwarded to frame manager interface 706. This approach advantageously reduces the amount of time that section data must reside in section manager 406 and also reduces the amount of memory and control logic needed to implement section manager 406.

To increase performance, SM control logic 704 is also configured to perform a partial CRC of each section on the fly as section data is received from TS packet filter 406. Current partial CRC results for each section currently being built are stored in section status data structure 726. The performance of the partial CRC results in the generation of erasure bits corresponding to each byte of frame data that is passed on to frame manager 408. Erasure bits advantageously need not be stored within section manager 406.

Control logic 704 also maintains a frame status data structure 724 that is used to facilitate the transmission of frame-related status and control information to frame manager 408. Frame status data structure 724 allows the status of eight frames to be maintained in parallel. Status information maintained for each frame may include, but is not limited to, whether or not the frame is valid, the PID associated with the frame, the value of a frame lookup pointer used to retrieve frame configuration data from frame configuration table 710, the number of good sections in the frame based on the CRC process, and whether or not the frame includes at least one bad section based on the CRC process.

Control logic 704 is also configured to keep track of real-time parameters associated with a frame in frame status data structure 724, such as delta_t values and table/frame boundaries. The delta_t values are derived from MPE-FEC headers associated with sections and serve to provide a indication of when the next time slice associated with a given PID will be received. Delta_t values are defined with a 10 ms resolution and may be updated by the transmitter with each section. By tracking the delta_t values in this manner, section manager 406 advantageously allows DVB-H receiver 400 to precisely identify time periods when no time slices are scheduled to be received by DVB-H receiver 400 and to turn off DVB-H demodulator 402 and other portions of DVB-H receiver 400 during such time periods. This results in a substantial power savings.

Control logic 704 is also configured to keep track of a table bit value in frame data structure 724 that indicates when the end of the application data table has been received for a given MPE-FEC frame as well as a frame bit that indicates when the end of a particular MPE-FEC frame has been reached. These bits are derived from MPE-FEC headers associated with sections. Tracking of these bits advantageously allows section manager 406 to identify when application table data padding is needed and to decide whether or not FEC processing should be performed. These features also provide a substantial power savings.

To facilitate the management of each frame and the transmission of frame information to frame manager 408, SM control logic 704 is also configured to access frame configuration table 710. Frame configuration table 710 is a table that includes frame configuration information for each of 32 PIDs and that is accessed using a pointer provided by TS packet filter 404 (pf_lkup_ptr [4:0]). Frame configuration information for each PID may include, but is not limited to, whether the PID is valid, whether or not only MPE-FEC sections should be processed for the PID, whether FEC operations will be performed for all frames associated with this PID, whether the PID is associated with an MPE-FEC service or an MPE only service, and the number of rows in an MPE-FEC frame for the PID. The number of rows for a given PID may be 256 rows, 512 rows, 768 rows or 1024 rows, wherein 256 rows corresponds to the smallest MPE-FEC frame size and 1024 rows corresponds to the largest MPE-FEC frame size. The information stored in frame configuration table 710 may be set by a host via host interface 708.

SM control logic 704 is also configured to access global configuration register 712. Global configuration register 712 stores parameters related to the operation of SM control logic 704 that are not associated with a particular PID. These parameters may include, but are not limited to, an indication that frames should be received by the host without performing MPE-FEC when all sections in the frame are deemed good based on the CRC process, a designation of a particular erasure marking scheme as discussed above, and an indication that a frame should be dropped if the number of bad sections in the frame (or a portion of the frame) exceed a minimum number, wherein the minimum number may itself be configurable.

When SM control logic 704 determines that section data corresponding to a new MPE-FEC frame has been received from TS packet filter 404, SM control logic 704 accesses frame configuration table 710 to determine the size of MPE-FEC frames for the PID associated with the new section. This access is made using the pf_lkup_ptr [4:0] provided by TS packet filter 404. Based on the frame size, SM control logic 704 then determines the number of frame buffers within frame manager 408 that would be needed to accommodate the new MPE-FEC frame. SM control logic 704 then compares the number of frame buffers needed to the number of frame buffers currently available, wherein the number of frame buffers currently available is provided as a signal from frame manager 408 via frame manager interface 706. If the number of frame buffers needed is greater than the number available, then SM control logic 704 will drop the new MPE-FEC frame. However, if the number of frame buffers needed is less than or equal to the number available, then SM control logic will initialize section- and frame-specific data structures for the new MPE-FEC frame and begin passing information pertaining to the new MPE-FEC frame to frame manager 408.

During the building of a given MPE-FEC frame, SM control logic 704 is responsible for providing frame data (which is derived from section data) and a logical address at which such frame data is to be stored to frame manager 408. SM control logic 704 is also responsible for providing erasure information associated with the frame data and, in some cases, a logical address at which such erasure information is to be stored within an erasure table to frame manager 408. As SM control logic 704 progresses in providing frame data and erasure information to frame manager 408, it updates relevant entries in section status data structure 726 and frame status data structure 724.

When SM control logic 704 determines that the end of an MPE-FEC frame has been reached, it notifies frame manager 408 and then clears all data structures currently being used to track the building of that MPE-FEC frame and sections associated therewith.

The communication of signals between section manager 406 and frame manager 408 is handled entirely by frame manager interface 706. The signals transmitted to frame manager 408 in accordance with one implementation of the present invention are set forth in Table 4 below. Each of these signals will now be described.

TABLE 4
Signals Output from Section Manager to Frame Manager

| Signal Name | Pins | Active |
|---|---|---|
| sm_pid [12:0] | 13 | N/A |
| sm_data [31:0] | 32 | N/A |
| sm_data_valid [3:0] | 4 | N/A |
| sm_data_ersr [31:0] | 32 | N/A |
| sm_ersr_valid [31:0] | 32 | N/A |
| sm_addr [17:0] | 18 | N/A |
| sm_erasure | 1 | High |
| sm_sof | 1 | High |
| sm_row_num [2:0] | 3 | N/A |
| sm_fecen | 1 | High |
| sm_table | 1 | High |
| sm_adt_ladr [17:0] | 18 | N/A |
| sm_adt_ladr_update | 1 | High |
| sm_rs | 1 | High |
| sm_frame | 1 | High |
| sm_lkup_ptr [4:0] | 5 | N/A |
| sm_bus_valid | 1 | High |
| sm_fecskip | 1 | High |
| sm_frmdscrd | 1 | High |
| sm_incomplete | 1 | High |

The signal sm_pid [12:0] is used to carry the 13-bit PID associated with the MPE-FEC frame or erasure information being transmitted to frame manager 408.

The signal sm_data [31:0] is used to carry 4 bytes of MPE-FEC frame data associated with the PID indicated by sm_pid. The signals sm_data [31:24], [23:16], [15:8] and [7:0] are intended for logical addresses sm_addr, sm_addr+1, sm_addr+2 and sm_addr+3, respectively.

The signal sm_data_valid [3:0] is used to indicate whether each data byte in sm_data [31:0] is valid. The signals sm_data_valid [3], [2], [1] and [0] correspond to sm_data [31:24], [23:16], [15:8] and [7:0], respectively.

The signal sm_data_ersr [31:0] is used to carry erasure bits associated the PID indicated by sm_pid. When sm_erasure is “0”, sm_data_ersr [3], [2], [1] and [0] carry erasure bits that correspond to sm_data [31:24], [23:16], [15:8] and [7:0], respectively. However, when sm_erasure is “1”, all 32 bits of sm_data_ersr [31:0] may be used to carry erasure bits.

The signal sm_ersr_valid [31:0] is used to indicate the valid status of each erasure bit. When sm_erasure is “0”, sm_ersr valid [3], [2], [1] and [0] correspond to sm_data_ersr [3], [2], [1], and [0], respectively. When sm_erasure is “1”, sm_ersr_valid [31:0] corresponds to sm_data_ersr [31:0], respectively.

The signal sm_addr [17:0] is used to carry a logical address within an MPE-FEC frame or erasure table at which to store data conveyed from section manager 406 to frame manager 408.

The signal sm_erasure is used to indicate which of two modes for conveying erasure information to frame manager 408 is being used, as discussed above with respect to signal sm_data_ersr [31:0]. When sm_erasure is “0”, sm_data [31:0], sm_data_valid [3:0], sm_data_ersr [31:0], sm_ersr valid [31:0] and sm_addr [17:0] are valid. When sm_erasure is “1”, sm_data [31:0] and sm_data_valid [3:0] should be ignored and sm_data_ersr [31:0], sm_ersr_valid [31:0] and sm_addr [17:0] are valid.

The signal sm_sof is asserted to indicate the start of the MPE-FEC frame or erasure bits associated with the PID indicated by sm_pid. The sm_sof signal is also used to validate the sm_lkup_ptr [4:0], sm_row_num [2:0] and sm_fecen signals.

The signal sm_row_num [2:0] indicates the total number of rows in the MPE-FEC frame that is associated with the PID indicated by sm_pid. In one implementation, a value of “000” denotes 256 rows, a value of “001” denotes 512 rows, a value of “010” denotes 768 rows, and a value of “011” denotes 1024 rows.

The signal sm_fecen is asserted to indicate that FEC is used in the MPE-FEC frame that is associated with the PID indicated by sm_pid. If this signal is not asserted, FEC is not used.

The signal sm_table is asserted to indicate the completion of a table within the MPE-FEC frame for which data is currently being transmitted to frame manager 308. When sm_table is “1” and sm_frame is “0”, the completion of the application data table is indicated. When sm_table is “1” and sm_frame is “1”, the completion of the Reed Solomon (RS) data table indicated.

The signal sm_adt_ladr [17:0] is used to convey the last data address in the application data table within the MPE-FEC frame currently being transmitted to frame manager 408.

The signal sm_adt_ladr_update is used to indicate a valid last data address in the Application Data Table. When sm_adt_ladr_update is “1”, sm_adt_ladr [17:0] is valid. Otherwise, sm_adt_ladr [17:0] should be ignored. The signal sm_adt_ladr_update should be asserted at least once for each MPE-FEC or MPE-only frame. The signal sm_adt_ladr_update is also used by frame manager 408 to gate sm_bus_valid—that is, when sm_adt_ladr_update is “1”, sm_bus_valid is treated as “0” by frame manager 408 regardless of the value set by section manager 406.

The signal sm_rs is asserted to indicate that MPE-FEC frame data carried by sm_data [31:0] is RS data.

The signal sm_frame is asserted to indicate the end of the MPE-FEC frame associated with the PID indicated by sm_pid. When sm_frame is “1”, sm_fec_skip, sm_frmdscrd and sm_incomplete are valid. Otherwise, sm_fec_skip, sm_frmdscrd and sm_incomplete should be ignored.

The signal sm_lkup_ptr [4:0] is a pointer that indicates the position of the PID indicated by sm_pid within frame configuration table 710. This pointer is passed via frame manager 408 to IP filter 410 and is used by IP filter 410 to access a similarly-organized table that is logically associated with TS packet filter table 612 and frame configuration table 710.

The signal sm_bus_valid is asserted to indicate the valid status of frame data and/or frame status signals transmitted from section manager 406 to frame manager 408. In particular, when sm_bus_valid is “1”, sm_pid, sm_data[31:0], sm_data_valid [3:0], sm_data_ersr [31:0], sm_ersr_valid [31:0], sm_addr [17:0], sm_erasure, sm_sof, sm_table, sm_rs and sm_frame are valid. Otherwise, these signals should be ignored.

The signal sm_fecskip is asserted to indicate to frame manager 408 that the MPE-FEC frame associated with the PID indicated by sm_pid does not need to undergo error correction and can instead be sent directly to IP filter 410.

The signal sm_frmdscrd is asserted to indicate to frame manager 408 that the MPE-FEC frame associated with the PID indicated by sm_pid should be discarded.

The signal sm_incomplete is asserted to indicate that the MPE-FEC frame associated with the PID indicated by sm_pid has a missing section.

The signals received from frame manager 408 via frame manager interface 706 in accordance with one implementation of the present invention are set forth in Table 5 below. Each of these signals will now be described.

TABLE 5
Signals Input to Section Manager from Frame Manager

| Signal Name | Pins | Active |
|---|---|---|
| fm_empty_buf [3:0] | 4 | N/A |
| fm_accept_sof | 1 | High |
| fm_accept_sof_val | 1 | High |
| fm_hold | 1 | High |

The signal fm_empty_buf indicates the number of empty frame buffers within frame manager 408. When fm_empty_buf [3:0] is “0000”, no frame buffers are available. When fm_empty_buf [3:0] is any value from “0001” through “1000”, the number of available frame buffers is binary encoded. The values “1001” through “1111” are reserved.

The signal fm_accept_sof, when asserted, indicates that frame manager 408 has accepted the sm_sof signal from section manager 406 and that a new frame has been started by frame manager 408.

The signal fm_accept_sof_val is used to indicate the valid status of the fm_accept_sof signal. When fm_accept_sof_val is “1”, fm_accept_sof is valid. Otherwise, fm_accept_sof should be ignored.

The signal fm_hold is used to indicate to section manager 406 that frame manager 408 is not ready for new receptions. When fm_hold is “1”, section manager 406 should not send any new data or status signals to frame manager 408 and, if sent, they will be ignored by frame manager 408.

4. Frame Manager

Among other functions, frame manager 408 is configured to receive frame data and associated status and control information from section manager 406 and to use this data to build MPE-FEC frames in frame buffers located within frame manager 408. Frame manager 408 is configured to build up to 8 separate MPE-FEC frames in parallel, depending on the frame sizes. Frame manager 408 is also configured to receive and store erasure information associated with each MPE-FEC frame. Frame manager 408 is further configured to perform MPE-FEC decoding operations on each buffered MPE-FEC frame (using the associated erasure information) and to make each decoded frame available for reading to IP filter 410.

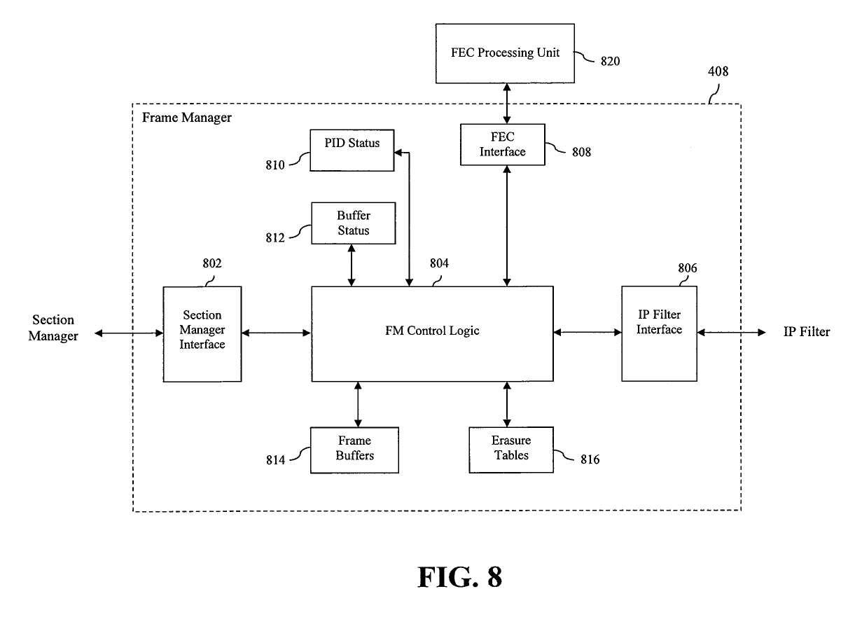

FIG. 8 is a block diagram that shows frame manager 408 in more detail. As shown in FIG. 8, frame manager 408 includes a number of interconnected logic blocks including a section manager interface 802, FM control logic 804, an IP filter interface 806, an FEC interface 808, a PID status table 810, a buffer status table 812, frame buffers 814, and erasure tables 816. Each of these logic blocks will be described in more detail below.

Section manager interface 802 is configured to handle the transmission of signals to section manager 406 and the receipt of signals from section manager 406. Signals transmitted to section manager 406 are described above in reference to Table 5. Signals received from section manager 406 are described above in reference to Table 4.

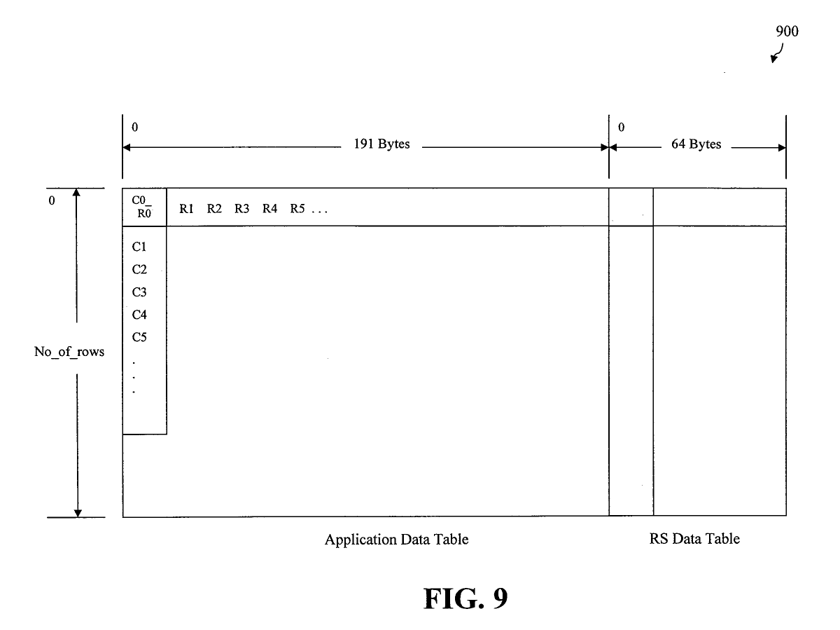

Frame manager 408 includes eight frame buffers 814, each frame buffer being capable of storing one minimal sized MPE-FEC frame. A logical representation 900 of an MPE-FEC frame is depicted in FIG. 9. Each MPE-FEC frame consists of 255 columns and 256, 512, 768 or 1024 rows. Thus, the minimal sized MPE-FEC frame has 256 rows while the largest sized MPE-FEC frame has 1024 rows. Each cell within the frame corresponds to a single byte and the maximum frame size is approximately 2 Mbits. As shown in FIG. 9, the frame is separated into two adjacent tables: an application data table and an RS data table.

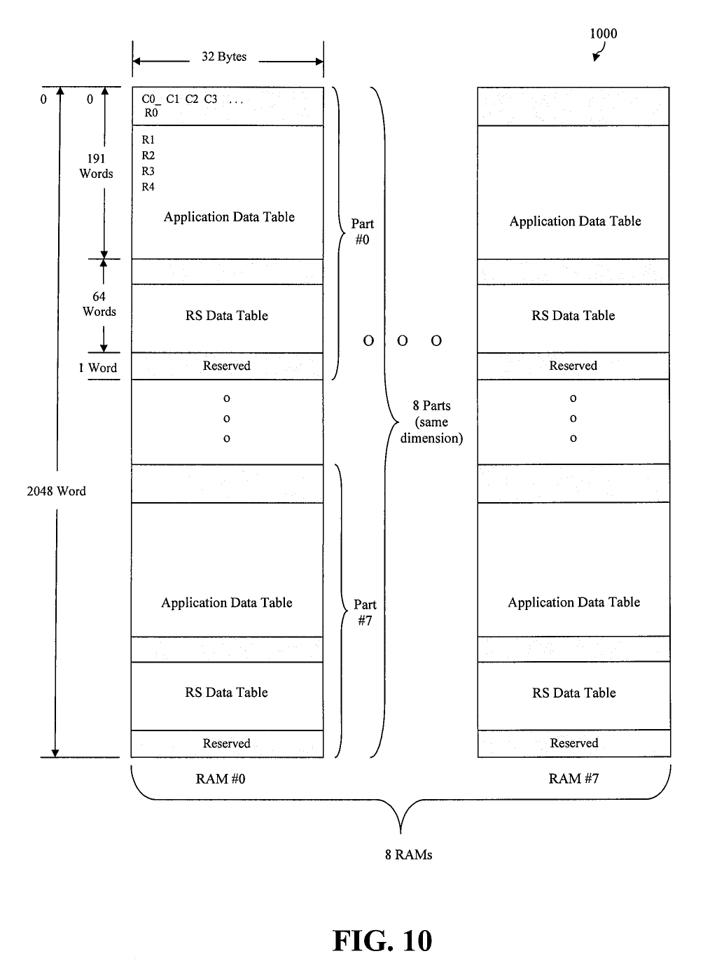

The physical implementation of the eight frame buffers 814 is shown in block diagram 1000 of FIG. 10. This implementation includes a total of eight random access memories (RAMs), denoted RAM #0 through RAM #7, each of which is subdivided into 8 parts, denoted part #0 through part #7. Each RAM is capable of storing one minimal sized MPE-FEC frame. All eight RAMs are of the same size, which is 524,288 bits (8 parts×256 words×32 bytes×8 bits).

Frame manager 408 also includes erasure tables 816 that correspond to the MPE-FEC frames stored in frame buffers 814. Erasure tables 816 are implemented using 8 RAMs. All of the RAMs are of the same size, which is 65,536 bits (8 parts×256 words×32 bits).

FM control logic 804 is configured to perform a variety of functions relating to the building of MPE-FEC frames and the performance of MPE-FEC decoding of those frames. Among other functions, FM control logic 804 manages the eight frame buffers 814 and dynamically allocates such buffers for concurrently building anywhere from one to eight MPE-FEC frames, depending on the size of such frames. To assist in managing frame buffers 814, FM control logic maintains a buffer status table 812 that indicates the usage of each frame buffer. FM control logic 804 further provides section manager 406 with information about the availability of frame buffers from buffer status table 812 so that section manager 406 can determine whether there is enough space to start a new MPE-FEC frame for an incoming elementary stream.

When a new MPE-FEC frame is started (denoted by the assertion of the sm_sof signal by section manager 406), FM control logic 804 obtains the PID, number of rows, and other information associated with the MPE-FEC frame from section manager interface 802 and uses such information to set up a new PID entry for the PID in PID status table 810. Based on the size of the MPE-FEC frame (sm_row_num [2:0]), and the number of available empty frame buffers according to buffer status table 812, FM control logic 804 selects one or more frame buffers to store the MPE-FEC frame. This information is written to the entry created for the PID in PID status table 810. PID status table 810 contains a maximum of eight entries. FM control logic 804 updates buffer status table 812 whenever a PID entry is added to or deleted from PID status table 810.

When frame data is received from section manager 406, FM control logic 804 accesses the PID status table to determine which frame buffer(s) should be used to store the associated MPE-FEC frame data. FM control logic 804 also translates logical addresses provided by section manager 406 to physical addresses at which to store the frame data within frame buffers 814. In one implementation, the RAMs used to implement frame buffers 814 are direct memory mapped to the RAMs used to implement erasure tables 816, such that the same address translation scheme can be used for storing erasure information received from section manager 406 as is used for storing frame data.

FM control logic 804 monitors the status of each MPE-FEC frame for which a PID entry has been created in PID status table 810 to determine when the MPE-FEC frame is ready for FEC processing. If an MPE-FEC frame is ready for FEC processing, then FM control logic 804 notifies FEC interface 808. Responsive to the notification, FEC interface 808 sends each row of the MPE-FEC frame to FEC processing unit 820 for error correction. After error correction, FEC interface 808 writes the data bytes back to their original location. When all the rows of an MPE-FEC frame have been corrected, FM control logic 804 updates the PID entry corresponding to the MPE-FEC frame. It should be noted that if sm_fec_skip was asserted for the MPE-FEC frame, then the frame will be sent directly to IP filter 410 without first being processed by FEC processing unit 820.

FM control logic 804 also monitors the status of each MPE-FEC frame for which a PID entry has been created in PID status table 810 to determine when the MPE-FEC frame is ready to be drained by IP filter 410. If an MPE-FEC frame is ready to be drained by IP filter 410, FM control logic 804 notifies IP filter 410 via IP filter interface 806 and also sends related PID information. FM control logic 804 then uses addresses supplied by IP filter 410 via IP filter interface 806 to read the MPE-FEC frame from the appropriate frame buffer(s) and associated erasure information from the appropriate erasure table and sends the frame data and erasure information to IP filter 410. FM control logic 804 uses an address translation scheme as discussed above to translate logical addresses provided by IP filter 410 to physical addresses within the appropriate frame buffer(s) and erasure table.

FM control logic 804 determines when an MPE-FEC frame has been drained by IP filter 410 by monitoring a frame done signal received from IP filter 410 via IP filter interface 806. Responsive to determining that an MPE-FEC frame has been drained by IP filter 410, FM control logic 804 deletes the PID entry associated with the MPE-FEC frame and recycles the frame buffers used by that MPE-FEC frame as well as the associated erasure table for the frame. Recycling of the frame buffers and erasure table involves initialization of the RAMs used to implement the frame buffers and erasure table.

IP filter interface 806 is configured to transmit and receive signals to and from IP filter 410. The signals transmitted to IP filter 410 in accordance with one implementation of the present invention are set forth in Table 6 below. Each of these signals will now be described.

TABLE 6
Signals Output from Frame Manager to IP Filter

| Signal Name | Pins | Active |
|---|---|---|
| fm_pid [12:0] | 13 | N/A |
| fm_lkup_ptr [4:0] | 5 | N/A |
| fm_row_num [2:0] | 3 | N/A |
| fm_adt_ladr [17:0] | 18 | N/A |
| fm_unccrctdrm | 1 | High |
| fm_sof | 1 | High |
| fm_all_drained | 1 | High |
| fm_pnd_frm [3:0] | 4 | N/A |
| fm_data [31:0] | 32 | N/A |
| fm_byte_ersr [3:0] | 4 | N/A |
| fm_data_valid | 1 | High |

The signal fm_pid [12:0] is used to carry the 13-bit PID associated with the MPE-FEC frame or erasure information being drained by IP filter 410.

The signal fm_lkup_ptr [4:0] is a pointer that indicates the position of the PID indicated by fm_pid within a lookup table. This pointer is passed from frame manager 408 to IP filter 410 and is used by IP filter 410 to access a table that is logically associated with TS packet filter table 612 and frame configuration table 710.

The signal fm_row_num [2:0] indicates the total number of rows in the MPE-FEC frame that is associated with the PID indicated by sm_pid. In one implementation, a value of “000” denotes 256 rows, a value of “001” denotes 512 rows, a value of “010” denotes 768 rows, and a value of “011” denotes 1024 rows.

The signal fm_adt_ladr [17:0] is used to convey the last data address in the application data table within the MPE-FEC frame currently being drained by IP filter 410.

The signal fm_uncrrctdfrm is asserted to indicate that the MPE-FEC frame identified by fm_pid [12:0] is uncorrectable by FEC processing unit 820.

The signal fm_sof is asserted to indicate that a completed MPE-FEC frame is ready for IP filter 410. The fm_sof signal is also used to validate the fm_pid, fm_lkup_ptr [4:0], fm_row_num [2:0], fm_adt_ladr [17:0], and fm_uncrrctedfrm signals.

The signal fm_all_drained is asserted when there are no valid frames in frame buffer 814.

The signal fm_pnd_frm [3:0] is used to indicate the number of pending frames in frame buffer 714, including the one currently in the process of being drained by IP filter 410.

The signal fm_data [31:0] is used to carry 4 bytes of MPE-FEC frame data associated with the PID indicated by fm_pid. The signals fm_data [31:24], [23:16], [15:8] and [7:0] are from addresses sm_addr, sm_addr+1, sm_addr+2 and sm_addr+3, respectively.

The signal fm_data_ersr [31:0] is used to indicate the erasure status of the frame data being drained by IP filter 410. The signals fm_data_ersr [3], [2], [1] and [0] carry erasure bits that correspond to fm_data [31:24], [23:16], [15:8] and [7:0], respectively. When a bit in fm_byte_ersr is “1”, this indicates that the corresponding data byte has been marked as erasure.

The signal fm_data_valid [3:0] is used to indicate the valid status of the frame data and erasure information. When fm_data_valid is “1”, fm_data [31:0] and fm_data_ersr [31:0] are valid. Otherwise, fm_data [31:0] and fm_data_ersr [31:0] should be ignored.

The signals received from IP filter 410 via IP filter interface 806 in accordance with one implementation of the present invention are set forth in Table 7 below. Each of these signals will now be described.

TABLE 7
Signals Input to Frame Manager from IP Filter

| Signal Name | Pins | Active |
|---|---|---|
| ipf_addr [17:0] | 18 | N/A |
| ipf_addr_valid | 1 | High |
| ipf_frm_done | 1 | High |

The signal ipf_addr [17:0] indicates the logical address in the MPE-FEC frame from which to read outgoing data.

The signal ipf_addr_valid indicates the valid status of the read address ipf_addr [17:0]. When ipf_addr_valid is “1”, ipf_addr [17:0] is valid. Otherwise, ipf_addr [17:0] should be ignored.

The signal ipf_frm_done indicates the end of the MPE-FEC frame currently being drained by IP filter 410. When ipf_frm_done is “1”, the MPE-FEC frame has been processed by IP filter 410 and thus may be discarded.

5. IP Filter

Among other features, IP filter 410 is configured to read data from the MPE-FEC frames built by frame manager 408 and to generate IP packets therefrom. MPE-FEC frames are read by IP filter 410 in a serial fashion. To perform this function, IP filter 410 is configured to provide logical addresses to frame manager 408 for reading data from MPE-FEC frames and to align data read from the MPE-FEC frames. Such data is drained in 4-byte segments. IP filter 410 also indicates to frame manager 408 when it has finished reading an MPE-FEC frame.

IP filter 410 is also configured to filter out selected IP packets from the generated IP packets for transfer to a host. The selected IP packets may be used by an application program executing on a system or device that is communicatively connected to DVB-H receiver 400 or that is executing on a system or device of which DVB-H receiver 400 is a part.

### D. Dynamic Memory Allocation in Accordance With an Alternate Embodiment of the Present Invention

As described above, frame manager 408 of DVB-H receiver 400 dynamically allocates frame-sized segments of memory for concurrently building up to eight MPE-FEC frames. In accordance with this approach, once a segment of memory has been allocated to a particular MPE-FEC frame, it remains dedicated to that frame until such time as the frame has been built and decoded by frame manager 408 and then drained by IP filter 410. Only after the frame has been completely drained by IP filter 410 can the allocated frame-sized segment be released for use in building one or more additional MPE-FEC frames. This approach imposes a limit on the number and/or size of the MPE-FEC frames that can be concurrently processed by DVB-H receiver 400.

In accordance with an alternate embodiment of the present invention, frame manager 408 is capable of dynamically allocating segments of memory to MPE-FEC frames that are smaller than the size of the frames. This advantageously permits frame manager 408 to allocate and release segments of available memory in a more flexible and efficient manner, thereby increasing the number and/or size of the MPE-FEC frames that can be concurrently processed by DVB-H receiver 400. For example, in accordance with this approach, once a segment of memory allocated to a first MPE-FEC frame has been drained by IP filter 410 it can be immediately be leveraged for building a different MPE-FEC frame, even though the first MPE-FEC frame has not yet been fully drained. Persons skilled in the relevant art(s) will readily appreciate that any size memory segment can be allocated by frame manager 408 to an MPE-FEC frame in accordance with this alternate embodiment of the present invention.

### E. Conclusion

While various embodiments of the present invention have been described above, it should be understood that they have been presented by way of example only, and not limitation. It will be understood by those skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A hardware-implemented video broadcasting receiver, comprising:
a transport stream packet filter configured to receive transport stream packets associated with a plurality of time slices;
a section manager connected to the transport stream packet filter, the section manager configured to track the building of sections associated with each of the plurality of time slices in parallel, wherein the sections are built using data from the transport stream packets;
a frame manager connected to the section manager, the frame manager configured to build MPE-FEC frames associated with each of the plurality of time slices in parallel, wherein the MPE-FEC frames are built using data from the sections and wherein building the MPE-FEC frames in parallel includes dynamically allocating one or more frame buffers within a plurality of frame buffers to each of the MPE-FEC frames; and
an Internet Protocol (IP) filter connected to the frame manager, the IP filter configured to generate IP packets from each of the MPE-FEC frames.

2. The receiver of claim 1, wherein the section manager is further configured to track the building of the MPE-FEC frames associated with each of the plurality of time slices in parallel.

3. The receiver of claim 1, further comprising:
a demodulator connected to the transport stream packet filter, the demodulator configured to receive in-phase (I) and quadrature (Q) signal components and to convert the received I and Q signal components to generate the transport stream packets.

4. The receiver of claim 1, wherein the section manager is configured to track the building of two to eight sections in parallel and wherein the frame manager is configured to build from two to eight MPE-FEC frames in parallel.

5. The receiver of claim 4, wherein the plurality of frame buffers consists of eight frame buffers.

6. The receiver of claim 5, wherein each frame buffer is configured to hold 256 rows of an MPE-FEC frame.

7. The receiver of claim 1, wherein the frame manager is configured to dynamically allocate a number of frame buffers to an MPE-FEC frame based on a frame size associated with the MPE-FEC frame.

8. The receiver of claim 1, wherein the section manager is configured to track the building of sections associated with a given time slice responsive to an indication that the frame manager can allocate a sufficient number of frame buffers to accommodate an MPE-FEC frame associated with the given time slice.

9. The receiver of claim 1, wherein the frame manager is configured to recycle one or more frame buffers allocated to an MPE-FEC frame responsive to determining that the MPE-FEC frame has been drained by the IP filter.

10. The receiver of claim 1, wherein the section manager is further configured to generate erasure information associated with each MPE-FEC frame and wherein the frame manager is configured to receive the erasure information and store it in an erasure table associated with the MPE-FEC frame.

11. A method for parallel processing of multiple time slices in a hardware-implemented video broadcasting receiver, comprising:
receiving transport stream packets associated with a plurality of time slices;
tracking the building of sections associated with each of the plurality of time slices in parallel, wherein the sections are built using data from the transport stream packets;
building MPE-FEC frames associated with each of the plurality of time slices in parallel, wherein the MPE-FEC frames are built using data from the sections and wherein building the MPE-FEC frames in parallel includes dynamically allocating one or more frame buffers within a plurality of frame buffers to each of the MPE-FEC frames; and
generating Internet Protocol (IP) packets from each one of the MPE-FEC frames.

12. The method of claim 11, further comprising:
tracking the building of the MPE-FEC frames associated with each of the plurality of time slices in parallel

13. The method of claim 11, further comprising:
receiving in-phase (I) and quadrature (Q) signal components; and
converting the received I and Q signal components to generate the transport stream packets.

14. The method of claim 11, wherein tracking the building of sections in parallel comprises tracking the building of two to eight sections in parallel and wherein building MPE-FEC frames in parallel comprises building an equal number of MPE-FEC frames in parallel.

15. The method of claim 14, wherein dynamically allocating one or more frame buffers within a plurality of frame buffers to each of the MPE-FEC frames comprises dynamically allocating one or more frame buffers within a set of eight frame buffers.

16. The method of claim 15, wherein each frame buffer is configured to hold 256 rows of an MPE-FEC frame.

17. The method of claim 11, wherein tracking the building of sections comprises tracking the building of sections associated with a given time slice responsive to an indication that a sufficient number of frame buffers can be allocated to accommodate an MPE-FEC frame associated with the given time slice.

18. The method of claim 11, further comprising:
recycling one or more frame buffers allocated to an MPE-FEC frame responsive to determining that the MPE-FEC frame has been drained by an IP filter.

19. The method of claim 10, further comprising:
generating erasure information associated with each MPE-FEC frame; and
storing the erasure information in an erasure table associated with the MPE-FEC frame.

20. A hardware-implemented video broadcasting receiver, comprising:
means for receiving transport stream packets associated with a plurality of time slices;
means for tracking the building of sections associated with each of the plurality of time slices in parallel, wherein the sections are built using data from the transport stream packets;
means for building MPE-FEC frames associated with each of the plurality of time slices in parallel, wherein the MPE-FEC frames are built using data from the sections and wherein building the MPE-FEC frames in parallel includes dynamically allocating one or more frame buffers within a plurality of frame buffers to each of the MPE-FEC frames; and
means for generating IP packets from each of the MPE-FEC frames.

21. The receiver of claim 20, further comprising:
means for tracking the building of the MPE-FEC frames associated with each of the plurality of time slices in parallel.

22. The receiver of claim 20, further comprising:
means for receiving in-phase (I) and quadrature (Q) signal components and for converting the received I and Q signal components to generate the transport stream packets.

23. The receiver of claim 20, wherein the means for tracking the building of sections comprises means for tracking the building of two to eight sections in parallel and wherein the means for building MPE-FEC frames comprises means for building from two to eight MPE-FEC frames in parallel.

24. The receiver of claim 23, wherein the plurality of frame buffers consists of eight frame buffers.

25. The receiver of claim 24, wherein each frame buffer is configured to hold 256 rows of an MPE-FEC frame.

26. The receiver of claim 20, wherein the means for tracking the building of sections comprises means for tracking the building of sections associated with a given time slice responsive to an indication that the means for building MPE-FEC frames can allocate a sufficient number of frame buffers to accommodate an MPE-FEC frame associated with the given time slice.

27. The receiver of claim 20, wherein the means for building frames comprises means for recycling one or more frame buffers allocated to an MPE-FEC frame responsive to determining that the MPE-FEC frame has been drained by the means for generating IP packets.

28. The receiver of claim 20, wherein the means for tracking the building of sections comprises means for generating erasure information associated with each MPE-FEC frame and wherein the means for building MPE-FEC frames comprises means for receiving the erasure information and storing it in an erasure table associated with the MPE-FEC frame.

29. A method for parallel processing of multiple time slices in a hardware-implemented video broadcasting receiver, comprising:
receiving transport stream packets associated with a plurality of time slices;
tracking the building of sections associated with each of the plurality of time slices in parallel, wherein the sections are built using data from the transport stream packets;
building MPE-FEC frames associated with each of the plurality of time slices in parallel, wherein the MPE-FEC frames are built using data from the sections and wherein building the MPE-FEC frames in parallel includes dynamically allocating one or more segments of memory to each of the MPE-FEC frames; and
generating Internet Protocol (IP) packets from each one of the MPE-FEC frames.

30. The method of claim 29, wherein dynamically allocating one or more segments of memory to an MPE-FEC frame comprises dynamically allocating a segment of memory to an MPE-FEC frame that is smaller than the size of the MPE-FEC frame.

31. The method of claim 29, further comprising:
recycling one or more segments allocated to an MPE-FEC frame responsive to determining that the one or more segments have been drained by an IP filter.
